(19) United States
(12) Patent Application Publication
(10) Pub. No.: US 2026/0000187 A1
(43) Pub. Date: Jan. 1, 2026

(54) System for Customization of Cosmetic Color

(71) Applicant: Blank Beauty, Inc., Knoxville, TN (US)

(72) Inventors: Charles Brandon, Knoxville, TN (US); Travis Floyd, Knoxville, TN (US); Amanda Braught, Knoxville, TN (US); Jenny Lam, Knoxville, TN (US); Walter Wallace, Knoxville, TN (US)

(73) Assignee: Blank Beauty, Inc., Knoxville, TN (US)

(21) Appl. No.: 19/251,017

(22) Filed: Jun. 26, 2025

Related U.S. Application Data
(60) Provisional application No. 63/664,819, filed on Jun. 27, 2024.

(51) Int. Cl. A45D 44/00; B01F 35/22; B01F 101/21

(52) U.S. Cl. CPC A45D 44/005; B01F 35/22; B01F 2101/21

(57) ABSTRACT

A system for formulating customized cosmetic products is provided that comprises an interface device allowing a user to select a cosmetic product and an additive, a single batch cosmetic device in electronic communication with the interface device configured to dispense the selected additive into a single batch cosmetic base, and a mixing assembly configured to mix the additive with the base to produce a customized cosmetic product. Various example embodiments of the present general inventive concept may also include a cosmetic cartridge configured for reversible attachment to a fluid connection of the dispensing assembly in the system, a method for formulating cosmetic products, and a method for registering cosmetic product colors from a set of proposed color options.

### CROSS-REFERENCE TO RELATED APPLICATIONS

This application claims the benefit of U.S. Provisional Patent Application Ser. No. 63/664,819, filed on Jun. 27, 2024, the content of which is incorporated herein by reference.

### STATEMENT REGARDING FEDERALLY SPONSORED RESEARCH OR DEVELOPMENT

Not Applicable.

### FIELD OF INVENTION

The present general inventive concept pertains to a system and a method to customize cosmetic color.

### BACKGROUND

With the development of the beauty industry, users are increasingly interested in beauty products such as custom cosmetics and beauty services. Specifically, a user needs a system for customizing a cosmetic product whereby the system enables accurate cosmetic color selection.

In the field of custom cosmetics, skin coloration has been measured spectrophotometrically to provide a custom color. A mixing and dispensing device is electronically connected to a processor programmed to provide custom-blended cosmetics in a retail location/environment. In this device, color blenders, cosmetic bases, thinners, and additives are dispensed via a plurality of nozzles into a container and mixed. Various vibration mixers and shakers are used to mix the required ingredients. However, due to the number of ingredients being mixed and the complexity of the process, this device is only for commercial use. A need exists in the industry to produce a system for a simple machine for in-home, salon, in-store, or alternative manufacturing use, providing users with the ability to customize cosmetics accurately to a selected color.

### BRIEF SUMMARY OF THE INVENTION

In one aspect, the present disclosure relates to a system to formulate a plurality of types of cosmetic products. This system may include a computer application deployed on an interface device to facilitate a cosmetic product selection and a cosmetic additive selection. The cosmetic additive selection may be made of at least a color selection, and the cosmetic product selection may include at least a product selection. A single batch cosmetic device may be provided in electronic communication with the interface device. The interface device may be configured to input the cosmetic product selection and the cosmetic additive selection to the single batch cosmetic device. The single batch cosmetic device may be made of a controller configured to control the operations of the single batch cosmetic device, a plurality of reservoirs for the cosmetic additive, and a dispensing assembly, wherein the dispensing assembly may be made of a plurality of fluid connections. Each of the fluid connections may be in direct fluid connection with the plurality of reservoirs by a plurality of tubes. A plurality of pumps and a plurality of pump motors may be provided for controlling the dispensing of at least one cosmetic additive from the at least one of the plurality of reservoirs to dispense through at least one of the plurality of fluid connections. The interface device may be configured to input the command code to the dispensing assembly to dispense the at least one cosmetic additive. A container may be provided to import into the single batch cosmetic device. The container may contain a base-specific for the cosmetic product selection. At least one mixer may be provided for mixing at least one cosmetic additive with the base-specific for the cosmetic product selection.

In other aspects, the present disclosure also relates to a method to formulate one of a plurality of types of cosmetic products with a selected color. The operations associated with this method may include inputting a cosmetic selection into an interface device, and inputting a color selection into the interface device to provide a selected cosmetic product. The interface device may be in electronic communication with a single batch cosmetic device The operations associated with the method may also include inserting a container into the single batch cosmetic device configured to formulate the plurality of custom cosmetic products. The container may contain a base for the selected cosmetic product. The container may also comprise an integral mixing element. The operations may also include dispensing the selected cosmetic additive into the base in the container from one of a plurality of cosmetic reservoirs using a dispensing assembly, and mixing the cosmetic additive with the base in the container to form the selected cosmetic product with a selected color.

Advantages of the presently disclosed subject matter will become evident to those of ordinary skill in the art after a study of the description, figures, and non-limiting examples in this document.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is an overview of an exemplary system embodiment of the present general inventive concept;

FIG. 2 is a more detailed overview of the system of FIG. 1;

FIG. 3 illustrates an isometric view of a generic mixer inserted from the top side of the container, in accordance with an exemplary embodiment of the present general inventive concept;

FIG. 4 shows a front side view of a cosmetic cartridge serving as a cosmetic reservoir, in accordance with an exemplary embodiment of the present general inventive concept; and

FIG. 5A is a schematic diagram of a process for generating a cosmetic product color registry.

FIG. 5B is a schematic diagram of a process in which a user selects a product color, prompting the system to dispense the corresponding color additive(s) based on that selection.

### DETAILED DESCRIPTION

Reference will now be made to the example embodiments of the present general inventive concept, examples of which are illustrated in the accompanying drawings and illustrations. The following detailed description is provided to assist the reader in gaining a comprehensive understanding of the structures and fabrication techniques described herein. However, it is to be understood that that the inventive subject matter of the present general inventive concept is not limited to the specific devices, methods, conditions or parameters described herein and that the terminology used herein is for describing embodiments by way of example only and is not intended to be limiting of the claimed inventive concept. Accordingly, various changes, modification, and equivalents of the structures and fabrication techniques described herein will be suggested to those of ordinary skill in the art.

As used in the specification including the appended claims, the singular forms “a,” “an,” and “the” include the plural, and reference to a numerical value includes at least that value unless the context dictates otherwise. Ranges can be expressed herein as from “about” or “approximately” one value and/or to “about” or “approximately” another value. When such a range is expressed, another embodiment includes from the one value and/or to the other value. Similarly, when values are expressed as approximations, by use of the antecedent “about,” it will be understood that the value forms another embodiment. Also, spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless defined otherwise, all technical and scientific terms used herein have the same meaning as commonly understood by one of ordinary skill in the art to which this inventive concept belongs. Also, description of well-known functions and constructions may be simplified and/or omitted for increased clarity and conciseness. However, the progression of fabrication operations described are merely examples, and the sequence type of operations is not limited to that set forth herein and may be changed as is known in the art, with the exception of operations necessarily occurring in a certain order. All combinations of method or process steps as used herein can be performed in any order, unless otherwise specified or clearly implied to the contrary by the context in which the referenced combination is made.

According to various example embodiments of the present general inventive concept, a system is provided that allows a user to make selections (e.g., product selection and cosmetic additive or color selection) on a user input module associated with a remote interface. In various embodiments, the selections are communicated to a single batch cosmetic device to formulate a plurality of custom cosmetic products, for example, by mixing the selected cosmetic additive and the base in a cosmetic container using at least one mixing element. In various example embodiments, the mixing element can be at least one insertable mixing head, a cosmetic wand or applicator, blade, or other device or system.

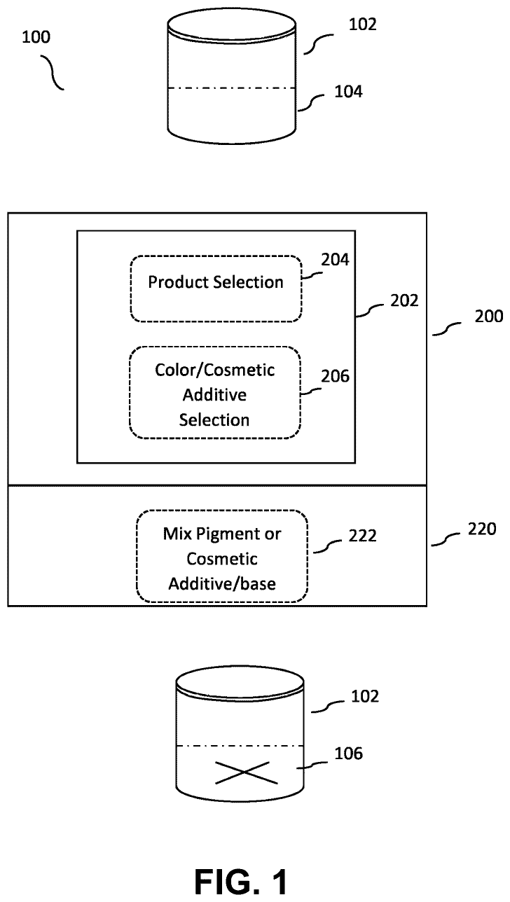

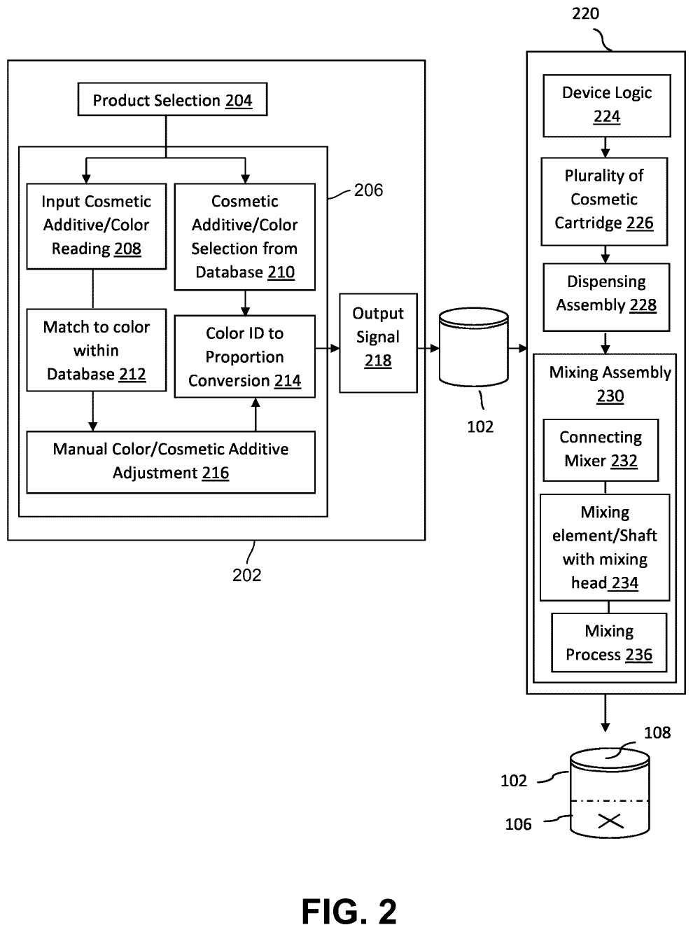

FIGS. 1 and 2 illustrate a system 100 for the automated delivery of customized cosmetics as a single batch. The system 100 has three primary components: a computer application 202 deployed on the interface device 200 configured to allow a product selection 204 and a cosmetic additive or color selection 206; a single batch cosmetic device 220; and a container 102 containing a base product 104 specific for a type of cosmetic product that can be chosen from a plurality of types of cosmetic products. The single batch cosmetic device 220 is configured to process a single batch of the desired cosmetic. As used herein, “single-batch” cosmetics may refer to individual units of a base product ready to be customized by a user. A user may customize product selection 202 and cosmetic additive or color selection 206 via a user input module included with the interface device 200, for example, a computerized user interface device providing user access to the computer application 202. The single batch cosmetic device 220 is configured to add or otherwise alter the base product 104 within the container 102 to comport with the selected cosmetic additive or color 206, thereby producing a formulated cosmetic product 106 within the container 102. The container 102 with the formulated cosmetic product 106 may then be removed from the single batch cosmetic device 220.

In one embodiment, the cosmetic additive or color can be selected 206 in one of two ways. In a first option, the user can select a cosmetic additive or color from a database 210 of colors. In another option, the user can match a cosmetic additive or color to an input 208, such as from a picture or photographic image. The user can match a color from an input image to a color within the database 212. The step of color matching involves providing the computer application 202 with an image to extract color information, wherein the extraction step involves picking a color from the image and identifying a color proportion value of the color. Once a color is valued, the representative proportion value of the color is identified 214 and electronically communicated 218 to the single batch cosmetic device 220. Optionally, in various example embodiments, the user can perform manual color/cosmetic additive adjustment 216 to comport to a desired finished color.

The single batch cosmetic device 220 is configured to dispense the pigment or cosmetic additive to the base 104 and to mix the dispensed pigment or cosmetic additive in the base 104. The single batch cosmetic device 220 can customize color cosmetics, including but not limited to: liquid makeups (such as concealer or foundation), liquid lip products (such as lip gloss or liquid lipstick), liquid eye products (such as mascara or eyeshadow) and nail polishes of a specified shade or composition. In one embodiment, a container 102 containing a base product 104 for a specified cosmetic is inserted into a single batch cosmetic device 220 for each cosmetic product that is desired. Each container 102 is sized to be imported into the single batch cosmetic device 220. The container 102, in an exemplary embodiment, pairs with a baseplate on the device.

The container 102 contains a base specific for a type of cosmetic product that can be chosen from a plurality of types of cosmetic products. Precise amounts of cosmetic additives such as a pigment are dispensed from one or more reservoirs within the single batch cosmetic device 220 as governed by a device logic 224 of the single batch cosmetic device 220 in operative communication with the interface device 200. The reservoirs may, for example, be cosmetic cartridges 226. Cosmetic additives are dispensed from the reservoirs according to the color identified or selected, or according to the color chosen by the user using the interface device 200, into the container 102 via the dispensing assembly 228. A mixing assembly 230 mixes the final product directly in the container 102 by connecting mixer 232 and performs a mixing process 236 using a mixing element 234. After completion, the mixer is returned to the initial state, if not included within the container 102, and the user can remove the finished product. In one example, the container 102 can be sealed with a lid or cap 108 to retain the formulated cosmetic 106 within the container 102.

In representative embodiments, the connecting mixer 232 allows a mixing element 234 powered by a motor to snap into an area of a mixing device (for example, the container) wherein the mixing element can be at least one of a disposable wand, blade, or other system to mix cosmetic additive with the base product inside the cosmetic container. Various containers, of the types that allow for the entry of or that include a mixing element 234 on the top or bottom of the container, may be used. In various embodiments, the connecting mixer 232 is configured in the mixing assembly so as to connect to a top portion of a container, to a bottom portion of a container, or configured to receive either container type.

In one example, the mixing assembly 230 is made of a connecting mixer 232 e.g., the mixing element or shaft with mixing head 234 that is connected with the container 102 to mix the contents inside the container 102, and can be easily removed when not in use. The mixing element 234 can enter from the top or bottom side opening of the container 102 to mix, blend, stir, agitate, or plunge the cosmetic additives such as pigments with the base product inside the container 102. In various embodiments, the mixing element is made of metal, durable plastics, biodegradable plastics, or other material and can be easily cleaned inside the container by the user if preferred. In one exemplary embodiment there is provided a disposable mixing element to connect with the cosmetic container to mix cosmetic additive with the base product inside the cosmetic container.

In another exemplary embodiment, the mixing element 234 or shaft with mixing head 234 can be stationary while the container 102 spins or rotates to agitate the cosmetic additive or pigment with the base product within the container 102, wherein the container spins or rotates from at least one side of the container (i.e., the top side, the bottom side, or the sidewalls of the container). The mixing element can be at least one of an impeller blade, squirrel cage, and homogenizer.

In yet another exemplary embodiment, the container has an integral mixing element (e.g., homogenizer) at the bottom side of the container to facilitate mixing inside the container. The mixing element can be a female element paired with a male mixing shaft. Further, in one example, the mixing element and its motor (e.g., a spinning cap motor/baseplate motor) and power source are built-in inside the container. The mixing element can be powered by an external power supply unit or a built-in battery. In yet another example, the mixing assembly 230 attaches or connects at least one or more spinning threads or wiry elements to the mixing element 234 (e.g., mixing rod, or shaft), such that when the mixing element 234 is inserted into the container 102 it can easily scrape off the content from the sidewalls of the container 102 during mixing process 236. The mixing element 234 can be a detachable and disposable or reusable mixing element.

In one embodiment, the remote interface device 200 may be a remote device including a processor with a memory capable of running a computer application 202 for a user to make product and color or cosmetic additive selections. The interface device 200 includes a user input module, for example a display device through which the user makes selections. This could be, for example, a touch screen in a remote interface device such as a smartphone, laptop, PDA or tablet.

In one exemplary embodiment, the lid 108 is configured to seal the container 102. The fluid conduits are configured to mate with the dispensing assembly to transfer the pigment or other cosmetic additives from a cosmetic reservoir to an inside of the cosmetic container. Also, the lid 108 in one embodiment can allow for a mixer to pass through and/or pair with an element of the lid 108 to mix the pigment or color additives with the base product and allow the pigment or color additives to transfer from the cosmetic reservoir to the container in a continuous fashion.

In another embodiment, a plurality of cosmetic reservoirs is configured to hold cosmetic additives such as specific liquid pigments, other cosmetic additives, or other liquids that are dispensed in accurate amounts to mix with the base product to modify the base product for creating a desired cosmetic product. The cosmetic additives can be, for example, pigments; formulation-adjusting additives such as thinners, product feel or texture altering agents; product differentiators such as glitter, shimmer, mattifying agents, holographic materials; or active ingredients for skincare such as SBF agents, acne treatments, blemish treatments, or hydrating treatments. A cosmetic reservoir can be disposable or refillable once the cosmetic additive is dispensed.

In yet another embodiment, and as illustrated in FIG. 2, the cosmetic reservoir is enabled to pair with the dispensing assembly 228 and/or mixing assembly 230. The cosmetic reservoir in this exemplary embodiment features at least one or more conduits, for example tubes, for extraction and/or dosing of the pigment or cosmetic additive by the dispensing assembly 228.

In one example, each cosmetic reservoir is a cosmetic cartridge 226 having at least one pump configured to be driven by a shaft connected to a single batch cosmetic device or using a built-in battery. In another example, the cosmetic reservoir is filled with one or more cosmetic additives and is actuated from at least a top or bottom end of the cosmetic reservoir to create pressure and dispense cosmetic additives from the cosmetic reservoir. Additionally, an external pump system can draw cosmetic additive contents from the cosmetic reservoirs via a tube or other type of conduit. The cosmetic reservoir is actuated using any type of actuator, for example, a linear actuator, stepper, screw, automated actuator system or manual mechanism (e.g., lever or button). In yet another example, the cosmetic reservoir can be an inkjet cartridge for dispensing an additive by a thermal or piezoelectric mechanism.

Referring again to FIG. 2, the dispensing assembly 228 of the single batch cosmetic device 220 includes a plurality of fluid connections for dispensing cosmetic additives such as a pigment from one or more of cosmetic cartridges 226 to the container 102. The fluid connections can be, for example, solenoids, manual valves, pressure valves, or check valves. The plurality of fluid connections is configured to control the cosmetic additive or pigment flow along at least one or more conduits, for example tubes from the cosmetic cartridges 226 or other cosmetic reservoirs to the dispensing tips of the dispensing assembly. Further, the plurality of fluid connections is configured to control the cosmetic additive or pigment flow within a pump that may be fluidly coupled or placed within a cosmetic reservoir. In one embodiment, the plurality of plugs is provided in which the plugs are designed to plug a fluid dispensing system in the dispensing assembly. The plugs can be manually inserted and positioned into a place after a pumping operation. Plug design can plug individual dispensing tips at once or may use multiple plugs for each dispensing area. In one embodiment, container 102 includes a dispensing area or area to insert the mixing element. The container 102 can be in various shapes and sizes and can be a threaded cosmetic container. In another embodiment, the cosmetic container 102 includes a mixing element that can be agitated externally such as ball bearings, magnetic stir rod, or any similar inclusions.

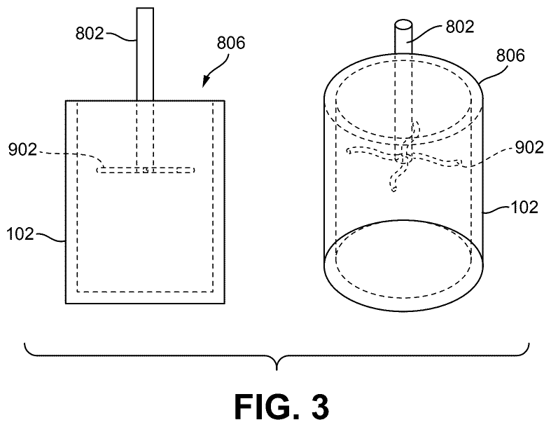

FIG. 3 illustrates an isometric view of a generic mixer 902 inserted from the top side 806 of the container 102, in accordance with an exemplary embodiment of the present general inventive concept. The generic mixing element can be impeller blade, homogenizer, screw, or another type mixing device attached to the mixing shaft 802. The mixing element can be a disposable or reusable mixing element.

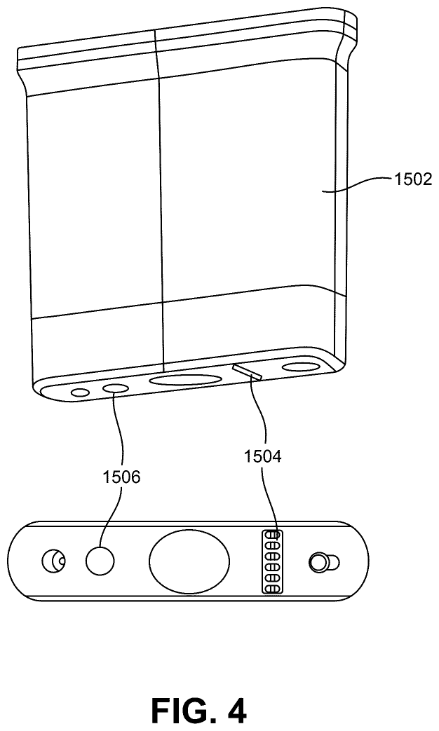

FIG. 4 shows a front side view of a cosmetic cartridge 1502, in accordance with an exemplary embodiment of the present general inventive concept. In an exemplary embodiment, the cosmetic cartridge 1502 has a substantially rectangular profile and is made from a rigid plastic. The cosmetic cartridge 1502 is filled with cosmetic additives such as pigments. The level of cosmetic additives within the cosmetic cartridge 1502 is monitored by a sensor electronically connected to a chip 1504 that can report data to the interface 200. In an exemplary embodiment, a groove in the top allows the cosmetic cartridge 1502 to reversibly attach with a single batch cosmetic device 220. In another embodiment, the attachment of the cosmetic cartridge 1502 to a single batch cosmetic device 220 can be accomplished by a magnet. The single batch cosmetic device 220 may include a plurality of cosmetic cartridges 1502 that are preferably supported in a ring structure (not shown). Port 1506 is fluidly coupled with the dispensing assembly 228. A plurality of fluid connections to the cosmetic cartridges 1502 control the flow of the cosmetic additives to the container 102.

Embodiments of the present general inventive concept may provide a threaded, screw-top jar container (e.g., a mason jar-like bottle) having a base product and a plastic seal above the fluid level. The plastic seal is removed, and cosmetic additives are dispensed into the container from the cosmetic reservoir. After dispensing, a “bottleneck” or “bottleneck and applicator” can be screwed onto the threads on the top of the mason jar container. The base product and cosmetic additive can be mixed from the top or from the bottom to be mixed with a mixing assembly.

Representative embodiments provide a single batch cosmetic device to create a desired customized product based on user inputs such as color or pigment/cosmetic additive selection. Pigment/cosmetic additive is dispensed to tint the base product to the selected color in a container such as 102. The single batch cosmetic device is configured to create a different customized cosmetic by use of a mixing means. The mixing means may be chosen from a homogenizer, propeller/impeller mixer, gate/squirrel cage mixer, helical/spiral/screw mixer, homogenizing tip/impeller blade, generic mixing element, mixing shaft and mixer, foundation/makeup brush, bristle/nail brush applicator having a mixing element, liquid lip product wand/applicator with mixing element, a magnetic mixing, ultrasonic mixing, vibrational mixing, vortex mixing, static mixing, and gyroscopic mixing.

The base product for liquid lip products can include emollients, waxes, colorants (pigment), thickening agents, and other additives such as fragrance or flavoring agents. Control agents can also be added to combat microbial growth. In one exemplary embodiment, the container for liquid lip products includes one or more of hydrogenated polyisobutene, ethylene/propylene/styrene copolymer, butylene/ethylene/styrene copolymer; titanium dioxide; a wax such as beeswax, carnauba, sumac wax, candelilla wax, ozokerite; an oil such as lanolin, polybutene, almond, coconut, avocado, jojoba, castor oil, linseed oil, sesame oil, shea butter, and silicone-based oils. The base product can be either a translucent product, a white-based product to have color added, the white pigment of the single batch device to provide the proper proportions of white in a certain shade (with the base product being a translucent mixture), or any of the previous three mixtures with additional cosmetic additive added. When the base product contains additional cosmetic additives, a user may adjust the color of a prior custom cosmetic product. The base product for nail polish can include polymers dissolved into a volatile, organic solvent, for example nitrocellulose dissolved in butyl acetate or ethyl acetate. Common ingredients also include plasticizers (to prevent brittleness), dyes and pigments, opalescent substances (to enhance coloration), adhesive polymers (to ensure nitrocellulose adheres to the surface of nails), thickening agents (to prevent premature settling of pigments), and ultraviolet stabilizers (to resist color change when exposed to sunlight). In one exemplary embodiment, the container for nail polish includes one or more of: butyl acetate, ethyl acetate, nitrocellulose, adipic acid/neopentyl glycol/trimellitic anhydride copolymer, acetyl tributyl citrate, isopropyl alcohol, acrylates copolymer, stearalkonium bentonite, N-butyl alcohol, styrene/scrylates copolymer, benzophenone-1, silica, alumina, trimethylpentanediyl dibenzoate, titanium dioxide, and an oil. In an additional embodiment, the container for nail polish includes a nitrocellulose-free, water-based formula with adhesive polymers. The base product for a liquid makeup can include oils and emollients, water, a silicone (dimethicone, polysiloxane, and the like), oils, and colorants. In one exemplary embodiment, the base product for a liquid makeup/foundation can include water, emulsifying ingredients such as dimethicone crosspolymer or polysilicone-11, titanium dioxide, iron oxides, viscosity controlling ingredients such as isohexadecane and cyclomethicone, mineral clays such as silica or kaolin, emollients such as glycerin or squalane, and natural preservatives.

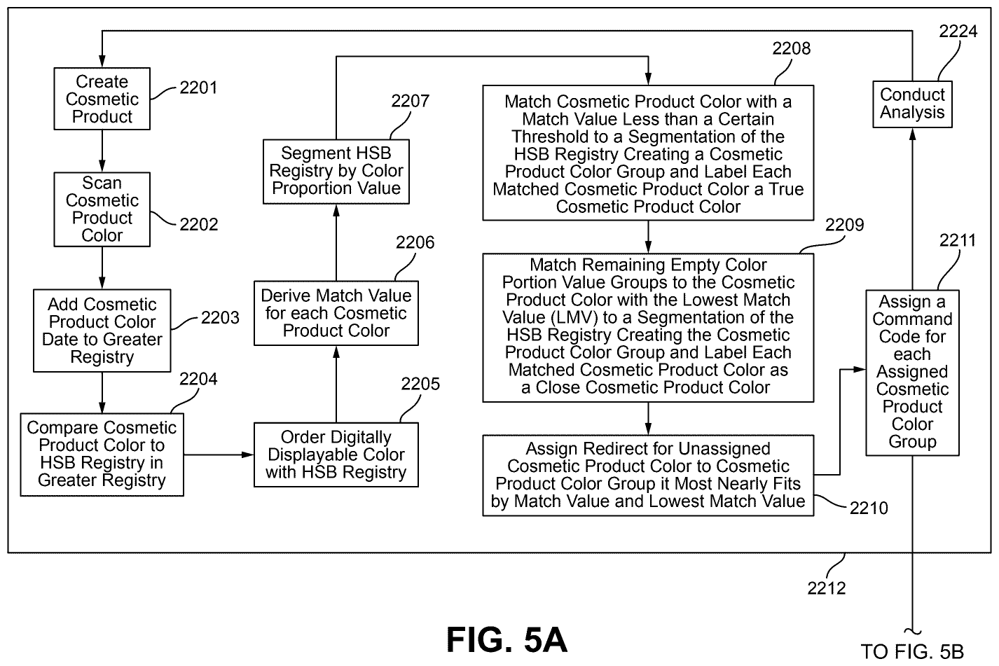

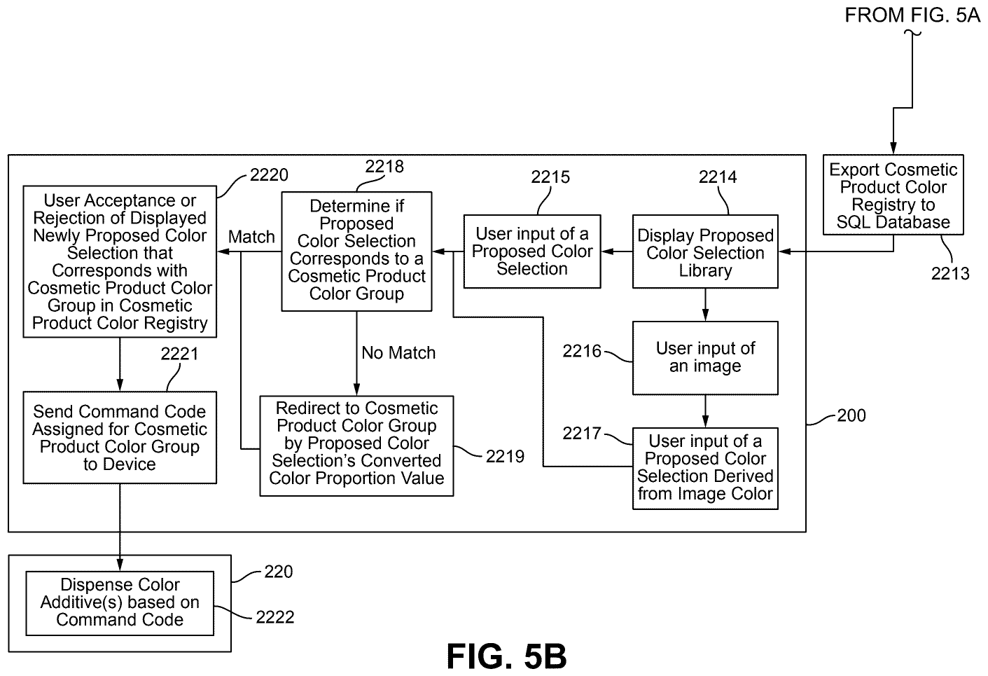

Now referring to the embodiment of FIG. 5B, the single batch cosmetic device 220 is in electronic communication with interface device 200 that is configured to dispense cosmetic product color that is relatively accurate to the user-selected color through a cosmetic product color registry. The cosmetic product color registry contains cosmetic product color groups. A cosmetic product color group is a segmentation of a color space registry by color proportion value which has assigned a cosmetic product color. Exemplary color space registries include but are not limited to HSB (Hue, Saturation, Brightness), RGB (Red, Green, Blue), and CMYK (Cyan, Magenta, Yellow, and Key (Black)). In the context of color space registries, the term “color proportion value” typically refers to the relative contribution of each component (like Red, Green, and Blue in RGB, or Hue, Saturation, and Brightness in HSB) to the overall color. HSB is a color space registry that defines a color by a measure of hue, saturation, and brightness of the visible color range. Hue can be defined as one of the perceived colors: red, yellow, green, and blue or to their combinations and is typically portrayed on a 360-degree scale. Brightness is a measure of the appearance of emission of light from a color. Saturation can be defined as a measure of color relative to its lightness, where lightness is a value defined by the brightness of a particular color relative to the brightness of a similarly illuminated white. For instance, 15 degrees on the Hue range is a representation of a red color. This hue with a brightness value of 0 will be totally black or totally white with a brightness of 100. This hue with a saturation value of 0 will be either totally white, grey, or black depending on its brightness. This hue with a saturation of 100 and a brightness in a medium range will be a vibrant red.

A cosmetic product color expert can use a “greater registry” and product color testing to segment color proportion values of a color space registry into groups so that a cosmetic product color will have relative accuracy to a digitally displayable color (2212). Relative accuracy is the resemblance of a digitally displayable color to a cosmetic product color. In some instances, the cosmetic product color is assigned by matching to a digitally displayable color using a match value, as illustrated hereinbelow.

As illustrated in FIG. 5A, a color space registry of colors defined by color proportion value is created, where the colors of the color space registry at least correspond to the range of color represented by a digital display device. A digital display device can be a computer screen, a phone screen, or a screen located on the mixing device. Cosmetic products are created by the single batch cosmetic device for testing 2201. The color of a cosmetic product is scanned to create cosmetic product color data 2202. In a representative example, the cosmetic product color is scanned by an RGB scanner and the RGB reading is converted to HSB color proportion values. The resulting cosmetic product color data is added to a greater registry that contains the segmented color space registry and the color data from scanned cosmetic products 2203. Alternatively, cosmetic product color data may be forecasted using trend analysis from existing cosmetic product color data. The greater registry includes after addition both the cosmetic product color data and the color space registry. The cosmetic product color can be assigned to segments of the segmented color space registry by a command code. The assigned segments become cosmetic product color groups, which are then exported as a cosmetic product color registry 2213 to a database in the interface device.

The cosmetic product color is compared with the color space registry (in this exemplary instance, the HSB color space registry) to identify groups within the registry for matching and assigning the cosmetic product color 2204. A digitally displayable color is then ordered with the HSB registry for display on an electronic device 2205. The electronic device may be a mobile phone, a computer, or other electrical device with a graphical user interface displaying color. In some instances, the digitally display color is ordered with the color space registry according to color proportion value. Cosmetic product color data is matched to one of the pluralities of cosmetic product color groups. In one instance, cosmetic product color is matched based on match value and a lowest match value. Match values may be derived from the cosmetic product colors and digitally displayable colors 2206. A match value is a color proportion value of the cosmetic product color minus a color proportion value of a digitally displayable color fitting within a segment of the segmented color space registry. Often a color expert may select the value in the middle of the segment, or the color expert may use a different value to fit a more accurate display of a custom cosmetic product. The match value threshold can be adjusted for each cosmetic product color group to select a cosmetic product color; but is less than a number that includes cosmetic product colors with color proportion values outside the range of color proportion values of a cosmetic product color group. A lowest match value is the match value with the smallest difference between the color proportion value of a scanned cosmetic product color and a color proportion value of a digitally displayable color fitting within a segment of the segmented color space registry. The color space registry is segmented so that a user associates a digitally displayable color with a cosmetic product color 2207.

In one instance, cosmetic product color is first assigned by a match value threshold 2208. Remaining cosmetic product colors are assigned by lowest match value until all potential cosmetic product groups in the segmented color space registry are filled 2209. The remaining cosmetic color product data in the greater registry is assigned redirect to the cosmetic product color group it most nearly fits by match value or lower match value 2210. Alternatively, this step is carried out in between creation of cosmetic product color groups.

Any cosmetic product color data assigned to a cosmetic product color group based on match value threshold is labeled a true cosmetic product color 2208. Any cosmetic product color data assigned to a cosmetic product color group based on lowest match value is labeled a close cosmetic product color 2209. In this way each of a plurality of cosmetic product colors is assigned a corresponding digitally displayable color whereby the digitally displayed color accurately reflects the cosmetic product color. The cosmetic product color groups together form a cosmetic product color registry. Each cosmetic product color group within the registry is assigned a command code 2211. In some instances, analysis is then conducted on the groups and the process is repeated until the desired effect of cosmetic product color accurately reflecting digitally displayable color in the perception of a processor is achieved (2224).

The cosmetic product color groups are exported as a cosmetic product color registry to an interface device 200. A user of the single batch cosmetic device 220 selects the proposed color selections from a proposed color selection library 2214. A proposed color selection is a user-selectable color on a digital display device. Other cosmetic additive selections may occur with or without proposed color selections to select cosmetic additives other than pigment for addition to the base product, such as formulation-adjusting additives, product differentiators, or active ingredients for skincare. In some instances, the proposed color selection library will include only true cosmetic product colors or close cosmetic product colors. In some instances, a proposed color selection library represents colors displayable by a digital display device. In some instances, a user inputs a proposed color selection from the proposed color selection library 2215. In some instances, a user inputs an image into the interface device 2216. The interface device 200 processes the image and is configured to allow the user to input a proposed color selection derived from the plurality of colors from the image 2217.

Once the user selects a proposed color selection, a computer application running on the interface device 200 determines if the proposed color selection corresponds with a cosmetic product color group in the cosmetic product color registry 2218. If there is a corresponding cosmetic product color group, the interface device 200 prompts the user to confirm or reject the cosmetic product color group 2220. If there is not a corresponding cosmetic product color group to the proposed color selection, the interface device 200 is configured to redirect to the cosmetic product color group with which the proposed color selection corresponds by color proportion value 2219. Once redirected, the interface device 200 can either prompt the user to confirm or reject the selection 2220. The interface device 200 responds to the user prompt by sending the command code 2221 registered with the cosmetic product color group to the single batch cosmetic device 220. Alternatively, the interface device 200 dispenses the cosmetic product color based on the command code assigned to the cosmetic product color group without user input. Once the single batch cosmetic device 220 receives the command code, it dispenses one or more cosmetic product color additives 2222. When the cosmetic product color additives are mixed with a base in the container, a cosmetic product with the color associated with that cosmetic product color group is created.

While the present general inventive concept has been described in detail with specific reference to embodiments thereof, it is understood that variations and modifications thereof are made without departing from the true spirit and scope of the present general inventive concept. Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A system for formulating customized cosmetic products, comprising:
an interface device, comprising:
a user input module configured to receive a cosmetic product selection and a cosmetic additive selection from a user, wherein the cosmetic additive selection comprises at least one color selection; and
a processor and memory configured to access a cosmetic product color registry and determine a cosmetic product color group based on a color proportion value associated with the color selection;
wherein the interface device is further configured to generate a command code corresponding to the cosmetic product selection and the determined cosmetic product color group;
a single batch cosmetic device in electronic communication with the interface device, the single batch cosmetic device comprising:
a controller configured to receive the command code from the interface device and control the operations of the single batch cosmetic device based on the received command code;
a dispensing assembly comprising a plurality of fluid connections, each configured for fluid coupling with at least one of a plurality of cosmetic additive reservoirs, and at least one pumping device configured to dispense at least one cosmetic additive from at least one of the plurality of reservoirs through at least one of the fluid connections into a container comprising a base specific to the cosmetic product selection; and
a mixing assembly configured to mix the at least one cosmetic additive with the base in the container to produce a customized cosmetic product.

2. The system of claim 1, wherein the interface processor and memory are further configured to enable a user to select a product and specify a color or cosmetic additive.

3. The system of claim 2, wherein the user input module comprises a touchscreen.

4. The system according to claim 1, further comprising a plurality of cosmetic additive reservoirs, wherein each reservoir is fluidly coupled with at least one of the fluid connections.

5. The system of claim 4, wherein the cosmetic additive reservoirs are removable cartridges.

6. The system of claim 1, wherein the mixing assembly is configured to mix the at least one cosmetic additive with the base inside a container with a mixing element powered by a motor.

7. The system of claim 6, wherein the mixing element is selected from the group consisting of an impeller blade, a squirrel cage, and a homogenizer.

8. A method for formulating cosmetic products, the method comprising:
receiving, via a user input module of an interface device, a cosmetic product selection from a user;
receiving, via the user input module, a cosmetic additive selection from the user, wherein the cosmetic additive selection comprises at least one color selection;
accessing a cosmetic product color registry;
determining a cosmetic product color group based on a color proportion value associated with the color selection;
generating a command code corresponding to the cosmetic product selection and the determined cosmetic product color group;
transmitting the command code from the interface device to a single batch cosmetic device in electronic communication with the interface device;
receiving, at the single batch cosmetic device, the transmitted command code;
controlling, via a controller of the single batch cosmetic device, a dispensing assembly based on the received command code, wherein the dispensing assembly comprises a plurality of fluid connections, each configured for fluid coupling with at least one of a plurality of cosmetic additive reservoirs;
actuating at least one pumping device to dispense at least one cosmetic additive from at least one of the plurality of reservoirs through at least one of the plurality of fluid connections into a container comprising a base specific to the cosmetic product selection; and
mixing, via a mixing assembly, the at least one cosmetic additive with the base to produce a customized cosmetic product.

9. The method of claim 8, wherein the interface device comprises a processor and memory configured to execute a computer application that enables a user to select a product and specify a color or cosmetic additive.

10. The method of claim 9, wherein the user input module is a touchscreen.

11. The method of claim 8, wherein the single batch cosmetic device further comprises a plurality of cosmetic additive reservoirs, wherein each reservoir is fluidly coupled with at least one of the fluid connections.

12. The method of claim 11, wherein the cosmetic additive reservoirs are removable cartridges.

13. The method of claim 8, wherein the mixing assembly is configured to mix the at least one cosmetic additive with the base inside a container with a mixing element powered by a motor.

14. The method of claim 8, wherein the mixing element is selected from the group consisting of an impeller blade, a squirrel cage, and a homogenizer.

15. A cosmetic cartridge configured for reversible attachment to a fluid connection of the dispensing assembly in the system of claim 1, the cartridge comprising:
a container enclosing a cosmetic additive;
a sensor configured to monitor the volume of cosmetic additive in the container, and
a communication chip electronically connected to the sensor and configured to transmit additive level data to the interface device to enable additive level monitoring and usage tracking.

16. A method for registering cosmetic product colors from a set of proposed color options, wherein a computer system including at least one processor, system memory, and a computer-readable medium storing executable instructions is configured to perform the method, the method comprising:
compiling a color space registry comprising a plurality of digitally displayable colors, each categorized by a color proportion value;
segmenting the color space registry into a plurality of segments based on the color proportion values, wherein the segmentation is derived from a mapping of human-perceived rankings of the relative accuracy of the digitally displayable colors with respect to a plurality of cosmetic product colors;
matching each of a plurality of cosmetic product colors with one of a plurality of cosmetic product color groups, wherein the matching comprises:
assigning a cosmetic product color to a cosmetic product color group when a match value is within a predefined threshold; and
for remaining unmatched cosmetic product color groups, assigning a cosmetic product color based on a lowest available match value;
redirecting each of a plurality of unassigned digitally displayable colors to a corresponding cosmetic product color group; and
registering each of the cosmetic product color groups by assigning a corresponding command code.

17. The method of claim 16 further comprising:
compiling a color space registry with a plurality of digitally displayable colors, each associated with a corresponding color proportion value;
segmenting the color space registry into color segments based on ranges of color proportion values; and
matching the color data of a plurality of cosmetic products each to one of a plurality of cosmetic product color groups, wherein a cosmetic product color group is derived from a mapping of human-perceived rankings of the relative accuracy of a segmented color space registry to a plurality of cosmetic product colors; and
registering each of the cosmetic product color groups by a command code.

18. The method of claim 17 wherein the matching comprises:
matching the cosmetic product color groups each with a cosmetic product color by a match value within a certain threshold; and
matching a remaining unassigned plurality of cosmetic product color groups each with a cosmetic product color by a lowest match value;
wherein a plurality of remaining digitally displayable colors is configured to redirect to one of the cosmetic product color groups.
